(19) United States
(12) Patent Application Publication
(10) Pub. No.: US 2016/0092917 A1
(43) Pub. Date: Mar. 31, 2016

(54) Data Sharing Between Service Providers and Applications

(71) Applicant: AT&T Mobility II LLC, Atlanta, GA (US)

(72) Inventors: Biren Parekh, Cumming, GA (US); Sheldon Kent Meredith, Roswell, GA (US)

(73) Assignee: AT&T Mobility II LLC, Atlanta, GA (US)

(21) Appl. No.: 14/497,448

(22) Filed: Sep. 26, 2014

(51) Int. Cl. G06Q 30/02; H04L 29/12; H04L 29/08; G06F 17/30

(52) U.S. Cl. CPC G06Q 30/0251; G06F 17/30424; H04L 61/609; H04L 67/10

(57) ABSTRACT

Concepts and technologies are disclosed herein for data sharing between service providers and applications. According to one aspect disclosed herein, a service provider data server computer can expose an application programming interface (“API”). The API can collect location data associated with a user device after an application that calls the API is launched by the user device. The service provider data server computer can receive the location data from the application. The service provider data server computer can determine a user associated with the location data and can obtain enrichment data associated with the user. The service provider data server computer can provide the enrichment data associated with the user to the application or to an application server computer for use in determining an advertisement targeted to the user.

### BACKGROUND

Some mobile applications can capture location data. While useful in some circumstances, location data alone does not provide an application developer with enough data to understand the application developer's user base. This proves difficult when the application developer relies upon advertisements within their application for financial support.

### SUMMARY

Concepts and technologies are disclosed herein for data sharing between service providers and applications. According to one aspect of the concepts and technologies disclosed herein, a computer storage medium stores computer-readable instructions. The computer-readable instructions can be executed by one or more processors of a service provider data server computer to cause the service provider data server computer to perform operations. The service provider data server computer can expose an application programming interface (“API”). The API can collect location data associated with a user device after an application that calls the API is launched by the user device. The service provider data server computer can receive the location data from the application. The service provider data server computer can determine a user associated with the location data. The service provider data server computer can obtain enrichment data associated with the user. The service provider data server computer can provide the enrichment data associated with the user to the application. In other embodiments, the service provider data server computer can provide the enrichment data associated with the user to an application server computer that generates an advertisement based, at least in part, upon the enrichment data and sends the advertisement to the application executing on the user device. The application can then present the advertisement to the user.

In some embodiments, the service provider data server computer can determine the user associated with the location data by determining a telephone number associated with a user device upon which the application is executed. The service provider data server computer can obtain the enrichment data by querying a user database for enrichment data associated with the telephone number and receiving the enrichment data from the user database in response.

In some embodiments, the enrichment data includes an age of the user, a gender of the user, a country in which the user lives, a country of which the user is a citizen, a city in which the user lives, a marital status of the user, an education level of the user, an interest of the user, a job of the user, a job sector of the user, an income level of the user, a living situation of the user, a time of day the application is used, a time of data another application is used, or any combination thereof.

In some embodiments, the service provider data server computer aggregates enrichment data to create aggregated enrichment data. The aggregated enrichment data can include, for example, an aggregate of user data associated with a plurality of users including the user. The aggregated enrichment data, for example, might include an overview of the dominant gender and age group that utilizes the application.

In some embodiments, the enrichment data can be utilized by the user device to target the user for a specific advertisement. In some other embodiments, an application server computer associated with the application can utilize the enrichment data to determine a specific advertisement for the user and can provide the specific advertisement to the user device.

According to another aspect of the concepts and technologies disclosed herein, a computer storage medium stores computer-readable instructions. The computer-readable instructions can be executed by one or more processors of a user device to cause the user device to perform operations. The user device can collect location data in response to an application being launched on the user device. The user device can collect the location data through an API that is exposed by a service provider data server computer and that is utilized by the application to obtain the location data. The user device can provide the location data to the service provider data server computer. The user device can receive, from the service provider data server computer, enrichment data associated with a user of the user device.

In some embodiments, the user device can determine an advertisement based, at least in part, upon the enrichment data. In some other embodiments, the user device can send the enrichment data to an application server computer associated with the application. The application server computer can determine an advertisement, based at least in part, upon the enrichment data and can send the advertisement to the user device. The user device can present the advertisement to the user

In some embodiments, the user is a subscriber of one or more telecommunications services provided by a service provider associated with the service provider data server computer.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating aspects of an illustrative operating environment for various concepts disclosed herein, according to an illustrative embodiment.

FIGS. 2-6 are flow diagrams illustrating aspects of methods for data sharing between service providers and applications, according to illustrative embodiments.

FIG. 7 is a block diagram illustrating an example mobile device capable of implementing aspects of the embodiments disclosed herein.

FIG. 8 is a block diagram illustrating an example computer system capable of implementing aspects of the embodiments presented herein.

FIG. 9 schematically illustrates a network, according to an illustrative embodiment.

### DETAILED DESCRIPTION

The concepts and technologies disclosed herein are directed to data sharing between service providers and applications. According to one aspect of the concepts and technologies disclosed herein, a service provider can create an application programming interface (“API”), and can expose the API to application developers so that the application developers can incorporate the API into applications. When an application that utilizes the API is launched, the API can be triggered to collect location data. The API may collect the location data once or may repeatedly collect location data for a pre-defined period of time. In either case, the application can provide the location data to a service provider data server computer associated with the service provider. The service provider data server computer can couple the location data to one or more data points (referred to herein as “enrichment data”) associated with one or more users of the application. The service provider data server computer can provide the enrichment data to the application and/or to an application server computer associated with the application so that the application and/or the application server computer can utilize the enrichment data to provide one or more advertisements targeted to the user(s).

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer system, including hand-held devices, mobile devices, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, example aspects of data sharing between service providers and applications will be presented.

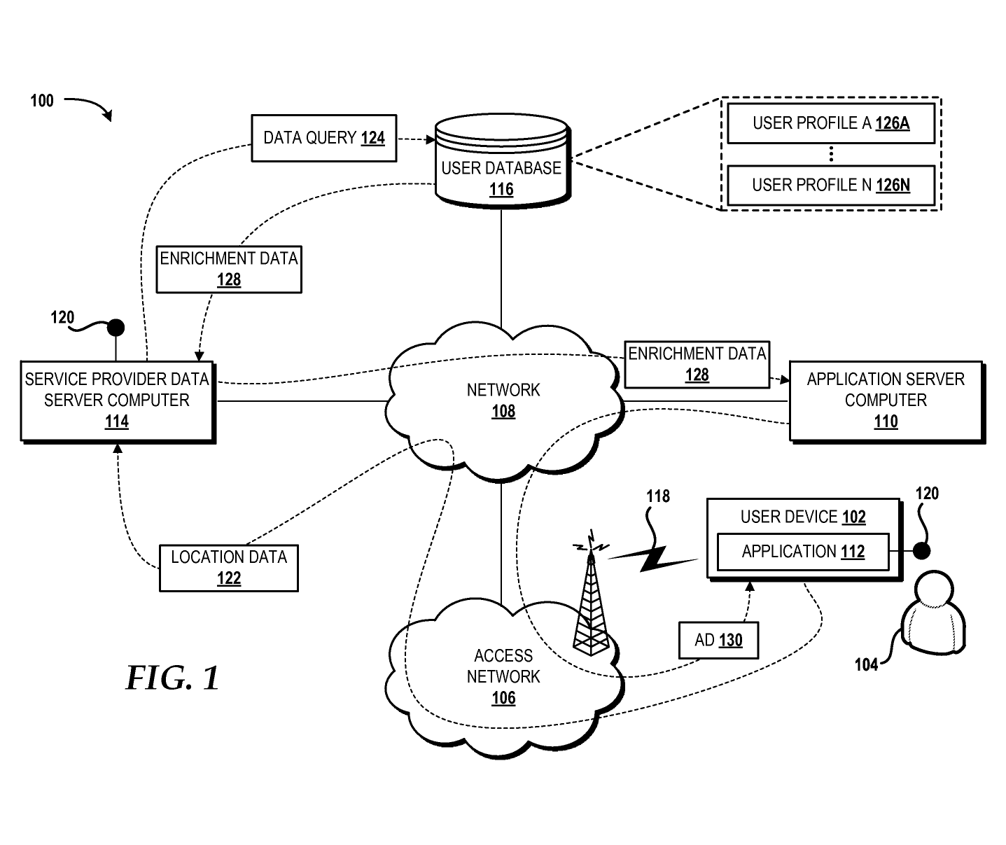

Referring now to FIG. 1, aspects of an operating environment 100 in which various embodiments presented herein may be implemented will be described, according to an illustrative embodiment. It should be understood that the operating environment 100 and the various components thereof have been greatly simplified for purposes of discussion. Accordingly, additional or alternative components of the operating environment 100 can be made available without departing from the embodiments described herein.

The operating environment 100 shown in FIG. 1 includes a user device 102 associated with a user 104. The illustrated user device 102 can connect to and communicate with an access network 106 to access a network 108 through which the user device 102 can communicate with an application server computer 110 associated with an application 112 that is executable by the user device 102, a service provider data server computer 114, a user database 116, and/or any other devices, computers, networks, and the like described herein. The user device 102 can utilize the access network 106, at least in part, for voice and/or data communications between the user device 102 and one or more other user devices (not shown).

The user device 102, in some embodiments, is or includes a cellular phone, a feature phone, a smartphone, a mobile computing device, a tablet computing device, a portable television, a portable video game console, or any other computing device that is configured to connect to and communicate with the access network 106 via one or more access components. In some embodiments, the user device 102 includes an integrated or external access component that facilitates wireless communication with the access network 106. The access component can be a cellular telephone that is in wired or wireless communication with the user device 102 to facilitate a tethered data connection to the access network 106. Alternatively, the access component includes a wireless transceiver configured to send data to and receive data from the access network 106 and a universal serial bus (“USB”) or another communication interface for connection to the user device 102 so as to enable tethering. In any case, the user device 102 can wirelessly communicate with the access network 106 over a radio/air interface 118 in accordance with one or more radio access technologies (“RATs”). The user device 102 can initiate, receive, and/or maintain voice calls with one or more other voice-enabled telecommunications devices such as other devices or landline devices (not shown). The user device 102 can also exchange Short Message Service (“SMS”) messages, Multimedia Message Service (“MMS”) messages, email, and/or other messages with other devices (not shown).

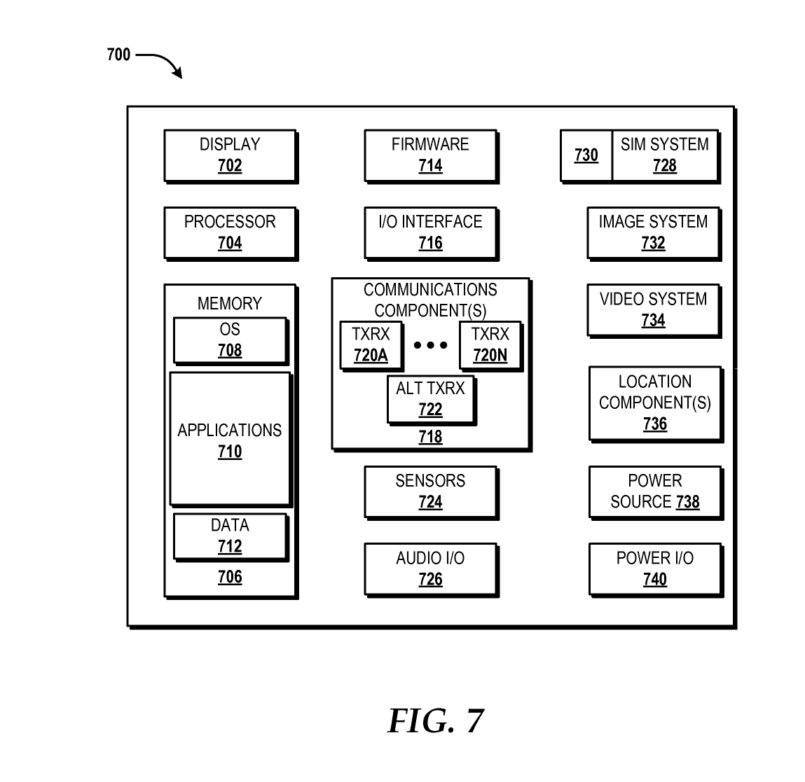

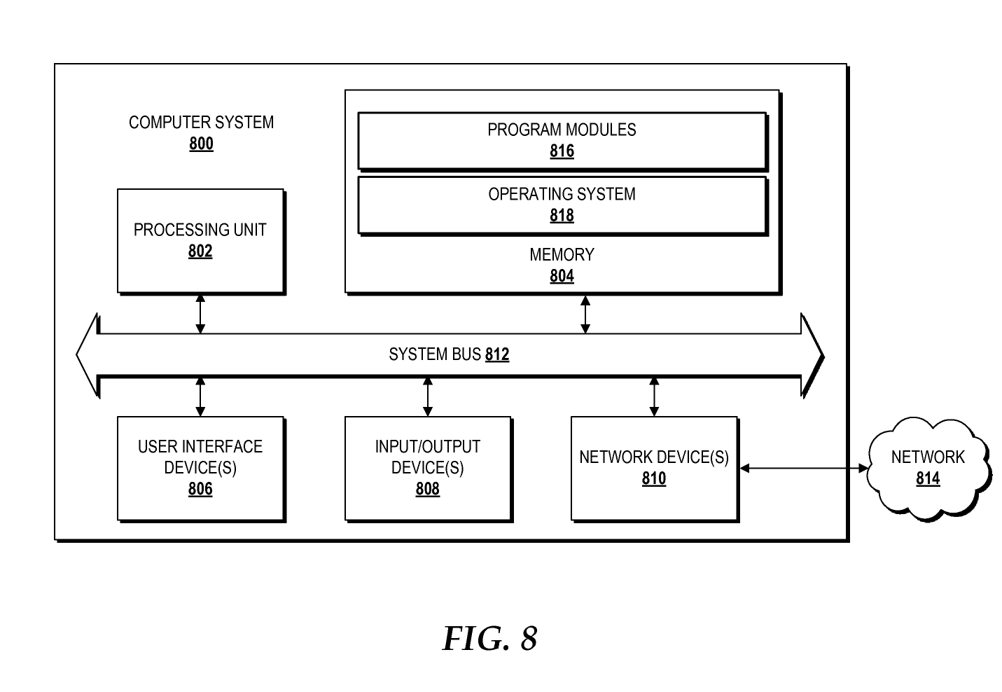

The user device 102 can utilize one or more processors (best shown in FIGS. 7 and 8) to execute one or more operating systems (also best shown in FIGS. 7 and 8). Briefly, the operating system(s) can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The user device 102 also can utilize the processor(s) to execute instructions associated with the application 112. The application 112 can include, but is not limited to, a productivity application, an entertainment application, a video application, a music application, a video game application, a camera application, a messaging application, a social network application, an enterprise application, a map application, a security application, a presence application, a visual voice mail application, an email application, a calendar application, a web browser application, and the like. The application 112 can execute on top of the operating system(s) briefly described above. The application 112 can utilize an API 120 exposed by the service provider data server computer 114 to collect location data 122 associated with a physical location of the user device 102.

The access network 106 can operate using various channel access methods, including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged via the access network 106 using cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), Long-Term Evolution (“LTE”), and/or various other current and future wireless data access technologies.

The user device 102 can launch the application 112. In response, the API 120 can be invoked by the application 112 to initiate collection of location data 122. The user device 102 can collect the location data 122 after the application 112 is launched, and in some embodiments, until a predetermined time thereafter in accordance with an application setting, for example. The user device 102 can utilize any network-based, device-based, subscriber identity module (“SIM”)-based, or hybrid location determining technique to generate the location data 122, some examples of which include, but are not limited to, triangulation, global positioning system (“GPS”), assisted-GPS (“A-GPS”) devices, cell ID, WI-FI positioning, and the like. The application 112 can instruct the user device 102 to provide the location data 122, via the access network 106 and the network 108, to the service provider data server computer 114.

The service provider data server computer 114 can receive the location data 122 from the user device 102. The service provider data server computer 114 can identify the user 104 associated with the location data 122. For example, the service provider data server computer 114 can associate a telephone number associated with the user device 102 with the location data 122. The service provider data server computer 114 can generate a data query 124 to determine one or more data points (hereinafter “enrichment data”) associated with the user 104. The service provider data server computer 114 can send the data query 124 to the user database 116. The user database 116 can store one or more user profiles 126A-126N (referred to herein collectively as “user profiles 126”). The user profiles 126 can contain data associated with one or more users of one or more services provided by a service provider that is associated with the service provider data server computer 114. In some embodiments, the service provider is a telecommunications service provider that provides one or more telecommunications services, for example, via the access network 106 and the network 108.

Each of the user profiles 126 can contain data that can be utilized by the service provider data server computer 114 to enrich the location data 122. This “enrichment data 128” can include demographic data, device usage data, service usage data, and the like. More specifically, the enrichment data 128 can include, but is not limited to, an age of the user 104, a gender of the user 104, a country in which the user 104 lives, a country of which the user 104 is a citizen, a city in which the user 104 lives, a marital status of the user 104, a number of children the user 104 has, an education level of the user 104, an interest of the user 104, a job of the user 104, a job sector of the user 104, an income level of the user 104 a living situation of the user 104, a time or times of day the application 112 is used by the user 104, a time or times of day another application is used by the user 104, other usage data, or any combination thereof.

In response to the data query 124, the user database 116 can perform a lookup operation to determine the user profile associated with the user 104, can extract the enrichment data 128 from the user profile, and can send the enrichment data 128 to the service provider data server computer 114. In some embodiments, the user database 116 alternatively provides the user profile associated with the user 104 to the service provider data server computer 114 in response to the data query 124.

In some embodiments, the service provider data server computer 114 provides the enrichment data 128 to the application server computer 110 as in the illustrated example. The application server computer 110 can utilize the enrichment data 128 to determine one or more advertisements (e.g., advertisement 130) that target the user 104 based, at least in part, upon the enrichment data 128. The application server computer 110 can provide the advertisement 130 to the user device 102 so that the application 112 can present the advertisement 130 to the user 104. Presentation of the advertisement 130 can be a visual presentation in which the advertisement 130 is presented via one or more displays of the user device 102 and/or can be an audible presentation in which the advertisement 130 is presented via one or more speakers of the user device 102. Other forms of presentation, including, but not limited to, haptic and thermal feedback are also contemplated and may be used to enhance visual and/or audible forms of presentation.

In some embodiments, the service provider data server computer 114 provides the enrichment data 128 to the user device 102. In these embodiments, the application 112 executing on the user device 102 can utilize the enrichment data 128 to determine the advertisement 130. The application 112 can then present the advertisement 130 as described above.

The application server computer 110, in some embodiments, performs application server functions in support of the application 112 that is executed by the user device 102. In addition, the application server computer 110 can determine one or more targeted advertisements as described above alone. It is contemplated that one or more other server computers (not shown) may be responsible for the determination of one or more targeted advertisements, which are then provided to the application server computer 110 and/or to the user device 102.

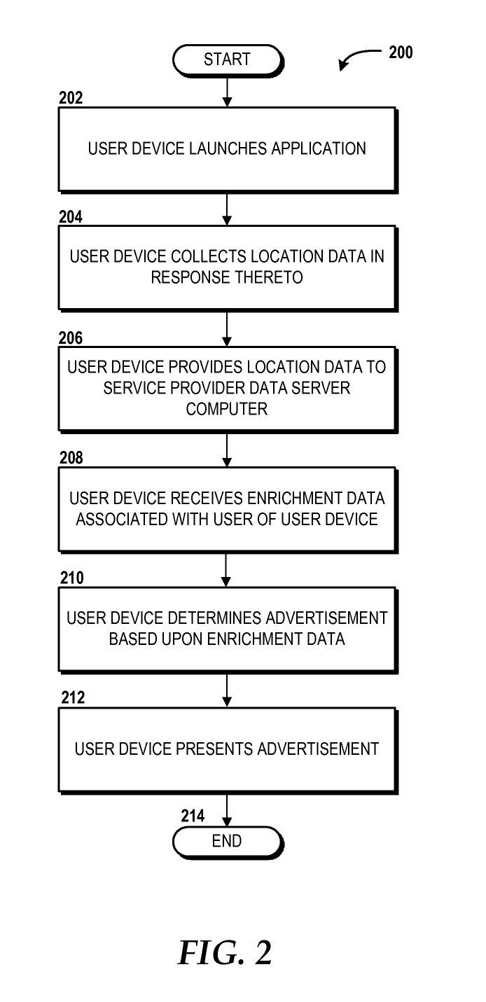

Turning now to FIG. 2, aspects of a method 200 for data sharing between service providers and applications will be described, according to an illustrative embodiment. It should be understood that the operations of the methods are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in their respective entireties. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including the user device 102, the service provider data server computer 114, the application server computer 110, the user database 116, single-processor or multiprocessor systems, minicomputers, mainframe computers, personal computers, hand-held computing devices, microprocessor-based, programmable consumer electronics, other devices and systems disclosed herein, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof refers to causing one or more processors of a computing system or device, such as the user device 102, the service provider data server computer 114, the application server computer 110, and/or the user database 116, to perform one or more operations and/or causing the processor to direct other components of the computing system or device to perform one or more of the operations.

For purposes of illustrating and describing some of the concepts of the present disclosure, the methods disclosed herein are described as being performed, at least in part, by the user device 102, the service provider data server computer 114 via execution, by one or more processor(s), of one or more software modules and/or software applications, such as, for example, the application 112 and/or the API 120. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 will be described with reference to FIG. 2 and further reference to FIG. 1. The method 200 begins at operation 202, where the user device 102 launches the application 112. From operation 202, the method 200 proceeds to operation 204, where the user device 102 collects location data (e.g., the location data 122) in response to the application 112 being launched. More particularly, at operation 204, the user device 102 can execute one or more functions provided by the API 120 to collect the location data 122.

From operation 204, the method 200 proceeds to operation 206, where the user device 102, and more particularly, the application 112 causes the user device 102 to provide the location data 122 to the service provider data server computer 114. From operation 206, the method 200 proceeds to operation 208, where the user device 102 receives enrichment data (e.g., the enrichment data 128) that is associated with the user 104.

From operation 208, the method 200 proceeds to operation 210, where the user device 102 determines an advertisement (e.g., the advertisement 130) based upon the enrichment data 128. From operation 210, the method 200 proceeds to operation 212, where the user device 102 presents the advertisement 130 to the user 104.

From operation 212, the method 200 proceeds to operation 214. The method 200 ends at operation 214.

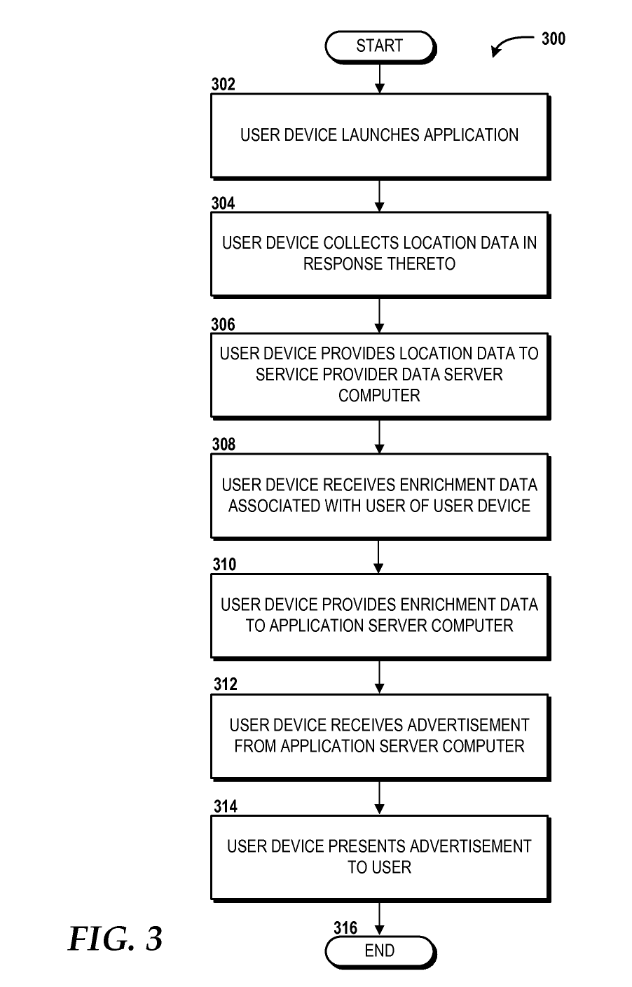

Turning now to FIG. 3, a method 300 for data sharing between service providers and applications will be described, according to an illustrative embodiment. The method 300 will be described with reference to FIG. 3 and further reference to FIG. 1. The method 300 begins at operation 302, where the user device 102 launches the application 112. From operation 302, the method 300 proceeds to operation 304, where the user device 102 collects location data (e.g., the location data 122) in response to the application 112 being launched. More particularly, at operation 304, the user device 102 can execute one or more functions associated with the API 120 to collect the location data 122.

From operation 304, the method 300 proceeds to operation 306, where the user device 102, and more particularly, the application 112 provides the location data 122 to the service provider data server computer 114. From operation 306, the method 300 proceeds to operation 308, where the user device 102 receives enrichment data (e.g., the enrichment data 128) that is associated with the user 104.

From operation 308, the method 300 proceeds to operation 310, where the user device 102 provides the enrichment data 128 to the application server computer 110. From operation 310, the method 300 proceeds to operation 312, where the user device 102 receives an advertisement that is based, at least in part, upon the enrichment data 128 (e.g., the advertisement 130) from the application server computer 110. From operation 312, the method 300 proceeds to operation 314, where the user device 102 presents the advertisement 130 to the user 104.

From operation 314, the method 300 proceeds to operation 316. The method 300 ends at operation 316.

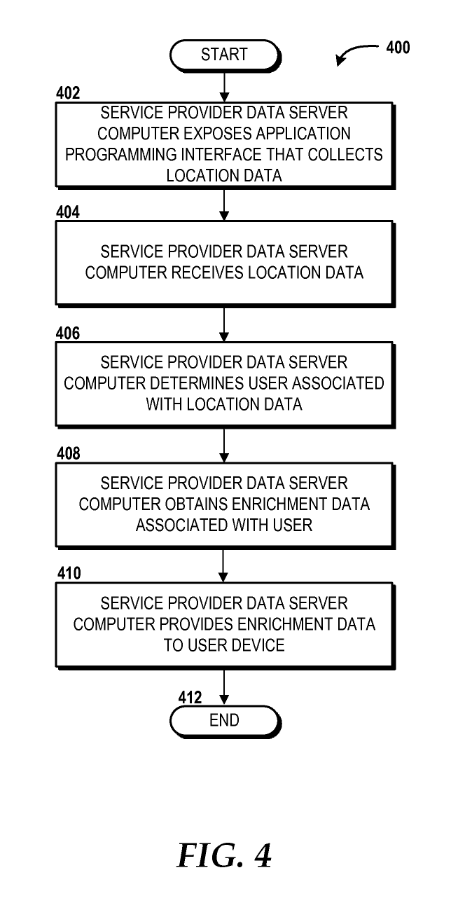

Turning now to FIG. 4, a method 400 for data sharing between service providers and applications will be described, according to an illustrative embodiment. The method 400 will be described with reference to FIG. 4 and further reference to FIG. 1. The method 400 begins at operation 402, where the service provider data server computer 114 exposes the API 120. From operation 402, the method 400 proceeds to operation 404, where the service provider data server computer 114 receives location data (e.g., the location data 122) from the user device 102.

From operation 404, the method 400 proceeds to operation 406, where the service provider data server computer 114 determines a user associated with the location data 122. In some embodiments, the service provider data server computer 114 determines a user associated with the location data 122 at least in part by determining a telephone number associated with the user device 102. From operation 406, the method 400 proceeds to operation 408, where the service provider data server computer 114 obtains enrichment data (e.g., the enrichment data 128) associated with the user 104. From operation 408, the method 400 proceeds to operation 410, where the service provider data server computer 114 provides the enrichment data 128 to the user device 102.

From operation 410, the method 400 proceeds to operation 412. The method 400 ends at operation 412.

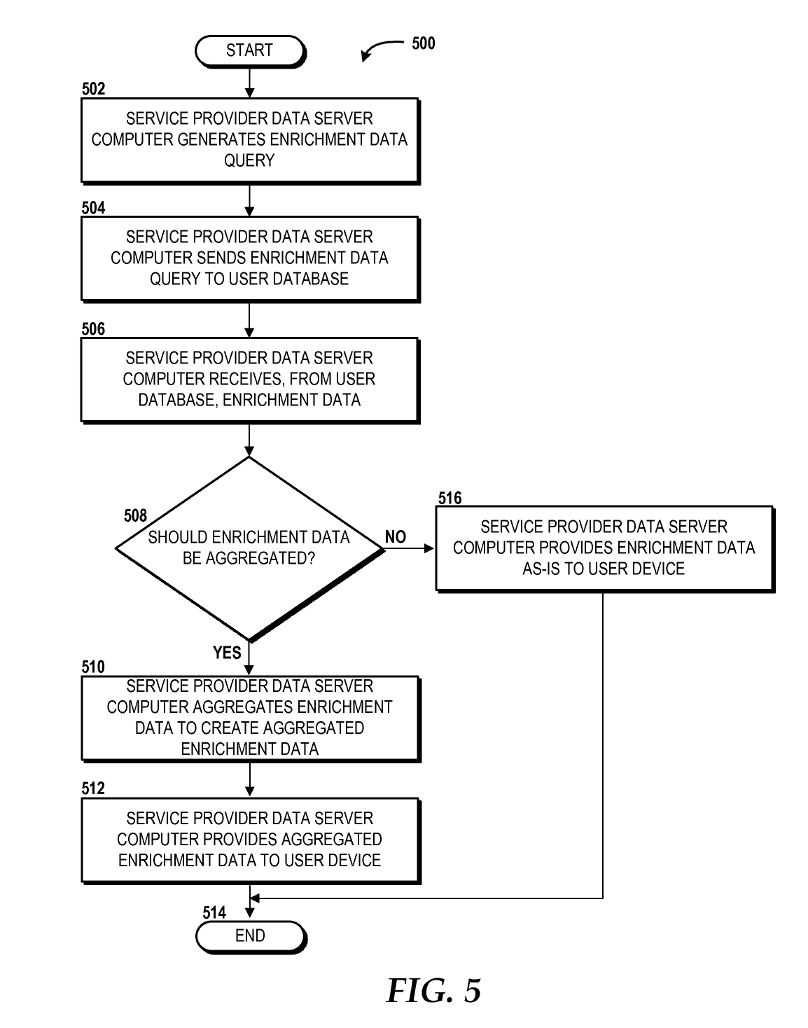

Turning now to FIG. 5, a method 500 for data sharing between service providers and applications will be described, according to an illustrative embodiment. The method 500 will be described with reference to FIG. 5 and further reference to FIG. 1. Moreover, the method 500 may be performed by the service provider data server computer 114 as at least part of the operations 408-410 of the method 400 described above.

The method 500 begins at operation 502, where the service provider data server computer 114 generates a data query (e.g., the data query 124) directed to the user database 116. From operation 502, the method 500 proceeds to operation 504, where the service provider data server computer 114 sends the data query 124 to the user database 116. The user database 116 performs one or more lookup operations to find a user profile associated with the user 104. The user database 116 can provide the entire user profile or a portion thereof in response as enrichment data (e.g., the enrichment data 128) in response to the data query 124. From operation 504, the method 500 proceeds to operation 506, where the service provider data server computer 114 receives, from the user database 116, the enrichment data 128.

From operation 506, the method 500 proceeds to operation 508, where the service provider data server computer 114 determines whether the enrichment data 128 should be aggregated with other enrichment data associated with one or more other users. If the service provider data server computer 114 determines that the enrichment data 128 should be aggregated, the method 500 proceeds to operation 510, where the service provider data server computer 114 aggregates the enrichment data 128 with other enrichment data associated with the one or more other users to create aggregated enrichment data. From operation 510, the method 500 proceeds to operation 512, where the service provider data server computer 114 provides the aggregated enrichment data to the user device 102.

From operation 512, the method 500 proceeds to operation 514. The method 500 ends at operation 514.

If, at operation 508, the service provider data server computer 114 determines that the enrichment data 128 should not be aggregated, the method 500 proceeds to operation 516, where the service provider data server computer 114 provides the enrichment data 128 as-is to the user device 102. The method 500 then proceeds to operation 514, where the method 500 ends.

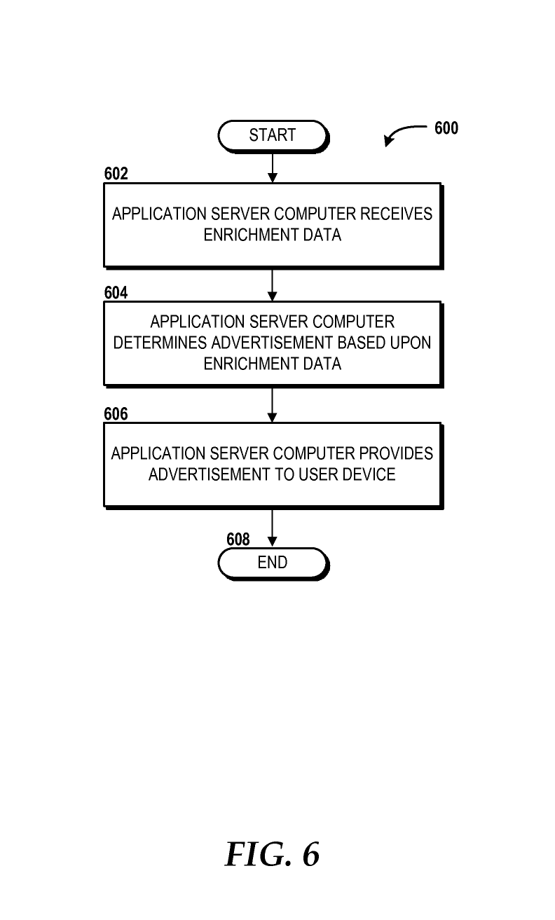

Turning now to FIG. 6, a method 600 for data sharing between service providers and applications will be described, according to an illustrative embodiment. The method 600 will be described with reference to FIG. 6 and further reference to FIG. 1. The method 600 begins at operation 602, where the application server computer 110 receives enrichment data (e.g., the enrichment data 128). In some embodiments, the application server computer 110 receives the enrichment data 128 from the user device 102. In some other embodiments, the application server computer 110 receives the enrichment data 128 from the service provider data server computer 114.

From operation 602, the method 600 proceeds to operation 604, where the application server computer 110 determines an advertisement (e.g., the advertisement 130) based, at least in part, upon the enrichment data 128. From operation 604, the method 600 proceeds to operation 606, where the application server computer 110 provides the advertisement 130 to the user device 102. The user device 102 can receive the advertisement 130 from the application server computer 110 and can provide the advertisement 130 to the application 112, which can cause the user device 102 to present the advertisement 130 to the user 104.

From operation 606, the method 600 proceeds to operation 608. The method 600 ends at operation 608.

Turning now to FIG. 7, an illustrative mobile device 700 and components thereof will be described. In some embodiments, the user device 102 described above can be configured as and/or can have an architecture similar or identical to the mobile device 700 described herein in FIG. 7. It should be understood, however, that the user device 102 may or may not include the functionality described herein with reference to FIG. 7. While connections are not shown between the various components illustrated in FIG. 7, it should be understood that some, none, or all of the components illustrated in FIG. 7 can be configured to interact with one other to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display the advertisement 130, various graphical user interface (“GUI”) elements, text, images, video, advertisements, various prompts, virtual keypads and/or keyboards, messaging data, notification messages, metadata, internet content, device status, time, date, calendar data, device preferences, map and location data, combinations thereof, and the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 (e.g., the application 112), the API 120, other computer-executable instructions stored in a memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, viewing account information, answering/initiating calls, entering/deleting data, entering and setting user IDs and passwords for device access, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include the enrichment data 128, the advertisement 130, user preferences, user settings, and/or other data. The applications 710 can include, for example, the application 112, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interfaced 716 can be configured to support the input/output of data such as location information, user information, organization information, presence status information, user IDs, passwords, and application initiation (start-up) requests. In some embodiments, the I/O interface 716 can include a hardwire connection such as USB port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the access network 106 and/or the network 108 described above herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMA, CDMAONE, CDMA2000, LTE, and various other 2G, 2.5G, 3G, 4G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using Generic Packet Radio Service (“GPRS”), Enhanced Date Rates for GSM Evolution (“EDGE”), the High-Speed Packet Access (“HSPA”) protocol family, including High-Speed Downlink Packet Access (“HSDPA”), Enhanced Uplink (“EUL”) or otherwise termed Highs-Speed Uplink Packet Access (“HSUPA”), HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near-field communications (“NFC”), other RF technologies, combinations thereof, and the like.

In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

FIG. 8 is a block diagram illustrating a computer system 800 configured to provide the functionality in accordance with various embodiments of the concepts and technologies disclosed herein. In some implementations, the user device 102, the application server computer 110, and/or the service provider data server computer is/are configured to utilize an architecture that is the same as or similar to the architecture of the computer system 800. It should be understood, however, that modification to the architecture may be made to facilitate certain interactions among elements described herein.

The computer system 800 includes a processing unit 802, a memory 804, one or more user interface devices 806, one or more input/output (“I/O”) devices 808, and one or more network devices 810, each of which is operatively connected to a system bus 812. The bus 812 enables bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, a system-on-a-chip, or other type of processor known to those skilled in the art and suitable for controlling the operation of the server computer. Processing units are generally known, and therefore are not described in further detail herein.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 818 and one or more program modules 816 (e.g., the API 120 and/or the application 112). The operating system 818 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 816 may include various software and/or program modules to perform the various operations described herein. The program modules 816 and/or other programs can be embodied in computer-readable media containing instructions that, when executed by the processing unit 802, perform one or more of the operations described herein. According to embodiments, the program modules 816 may be embodied in hardware, software, firmware, or any combination thereof. The memory 804 can also store other data, if desired.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium” and variations thereof does not include waves or signals per se and/or communication media.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer.

The network devices 810 enable the computer system 800 to communicate with other networks or remote systems via a network 814, such as the access network 106 and/or the network 108. Examples of the network devices 810 include, but are not limited to, a modem, a radio frequency (“RF”) or IR transceiver, a telephonic interface, a bridge, a router, or a network card. The network 814 may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 814 may be a wired network such as, but not limited to, a Wide Area Network (“WAN”), a wired LAN such as provided via Ethernet, a wired Personal Area Network (“PAN”), or a wired Metropolitan Area Network (“MAN”).

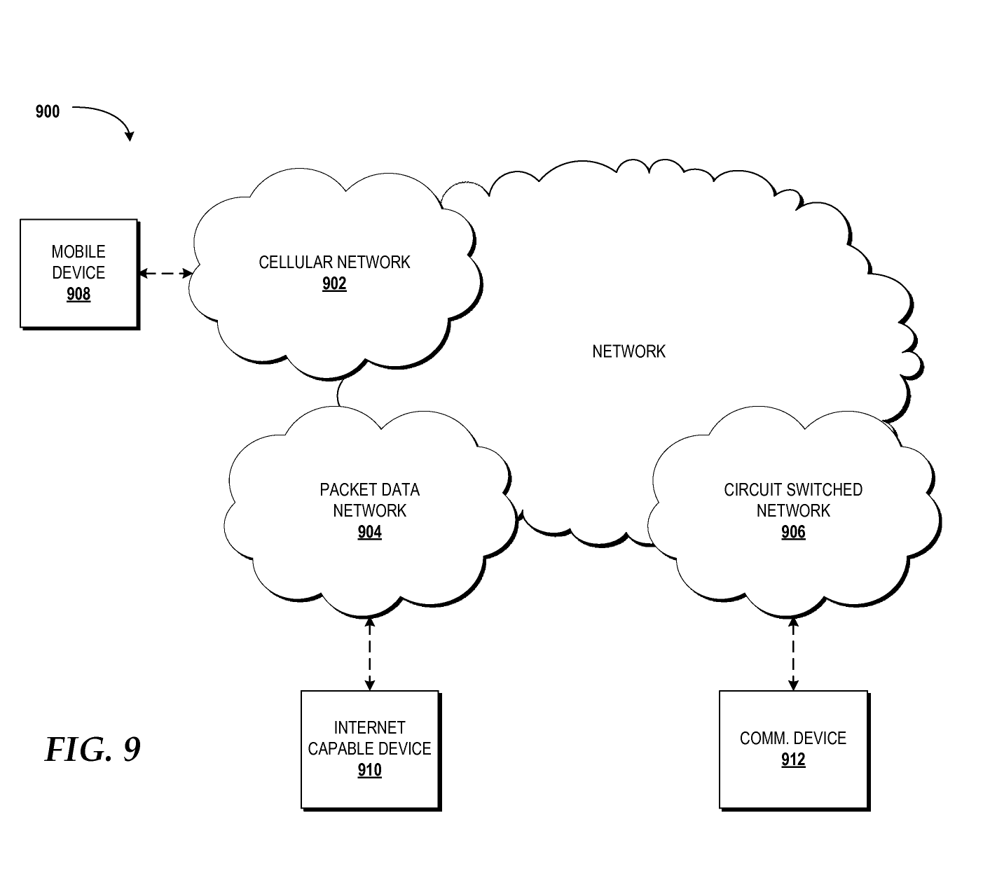

Turning now to FIG. 9, details of a network 900 will be described, according to an illustrative embodiment. The network 900 includes a cellular network 902, a packet data network 904, for example, the Internet, and a circuit switched network 906, for example, a publicly switched telephone network (“PSTN”). The cellular network 902 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 902 also includes radios and nodes for receiving and transmitting voice, data, and combinations thereof to and from radio transceivers, networks, the packet data network 904, and the circuit switched network 906. The cellular network 902 can include the access network 106 and/or the network 108, or vice versa.

A mobile communications device 908, such as, for example, a cellular telephone, a user equipment, a mobile terminal, a PDA, a laptop computer, a handheld computer, the user device 102, and combinations thereof, can be operatively connected to the cellular network 902. The cellular network 902 can be configured as a 2G GSM network and can provide data communications via GPRS and/or EDGE. Additionally, or alternatively, the cellular network 902 can be configured as a 3G UMTS network and can provide data communications via the HSPA protocol family, for example, HSDPA, EUL (also referred to as HSUPA), and HSPA+. The cellular network 902 also is compatible with 4G mobile communications standards such as LTE, or the like, as well as evolved and future mobile standards.

The packet data network 904 includes various devices, for example, servers, computers, databases, and other devices in communication with another, as is generally known. The packet data network 904 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 904 includes or is in communication with the Internet. The circuit switched network 906 includes various hardware and software for providing circuit switched communications. The circuit switched network 906 may include, or may be, what is often referred to as a plain old telephone system (“POTS”). The functionality of a circuit switched network 906 or other circuit-switched network are generally known and will not be described herein in detail.

The illustrated cellular network 902 is shown in communication with the packet data network 904 and a circuit switched network 906, though it should be appreciated that this is not necessarily the case. One or more Internet-capable devices 910, for example, the user device 102, a PC, a laptop, a portable device, or another suitable device, can communicate with one or more cellular networks 902, and devices connected thereto, through the packet data network 904. It also should be appreciated that the Internet-capable device 910 can communicate with the packet data network 904 through the circuit switched network 906, the cellular network 902, and/or via other networks (not illustrated).

As illustrated, a communications device 912, for example, a telephone, facsimile machine, modem, computer, the user device 102, or the like, can be in communication with the circuit switched network 906, and therethrough to the packet data network 904 and/or the cellular network 902. It should be appreciated that the communications device 912 can be an Internet-capable device, and can be substantially similar to the Internet-capable device 910.

Based on the foregoing, it should be appreciated that concepts and technologies directed to data sharing between service providers and applications have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. A computer storage medium that stores computer-readable instructions that, when executed by a processor of a service provider data server computer, cause the processor to perform operations comprising:
exposing an application programming interface, wherein the application programming interface collects location data when an application is launched;
receiving the location data from the application;
determining a user associated with the location data;
obtaining enrichment data associated with the user; and
providing the enrichment data associated with the user to the application.

2. The computer storage medium of claim 1, wherein determining the user associated with the location data comprises determining a telephone number of the user associated with the location data.

3. The computer storage medium of claim 2, wherein obtaining the enrichment data associated with the user comprises:
querying a user database for the enrichment data associated with the telephone number; and
receiving, from the user database, the enrichment data associated with the telephone number.

4. The computer storage medium of claim 3, wherein the enrichment data comprises an age of the user, a gender of the user, a country in which the user lives, a country of which the user is a citizen, a city in which the user lives, a marital status of the user, an education level of the user, an interest of the user, a job of the user, a job sector of the user, an income level of the user, a living situation of the user, a time of day the application is used, a time of data another application is used, or any combination thereof.

5. The computer storage medium of claim 3, wherein the operations further comprise aggregating the enrichment data to create aggregated enrichment data, and wherein providing the enrichment data associated with the user to the application comprises providing the aggregated enrichment data associated with the user to the application.

6. The computer storage medium of claim 1, wherein the enrichment data comprises an age of the user, a gender of the user, a country in which the user lives, a country of which the user is a citizen, a city in which the user lives, a marital status of the user, an education level of the user, an interest of the user, a job of the user, a job sector of the user, an income level of the user, a living situation of the user, a time of day the application is used, a time of data another application is used, or any combination thereof.

7. The computer storage medium of claim 6, wherein providing the enrichment data associated with the user to the application comprises providing the enrichment data associated with the user to the application so that the application can utilize the enrichment data to target the user for a specific advertisement.

8. A method comprising:
exposing, by a service provider data server computer comprising a processor, an application programming interface that collects location data when an application is launched;
receiving, by the service provider data server computer, the location data from the application;
determining, by the service provider data server computer, a user associated with the location data;
obtaining, service provider data server computer, enrichment data associated with the user; and
providing, service provider data server computer, the enrichment data associated with the user to the application.

9. The method of claim 8, wherein determining, by the service provider data server computer, the user associated with the location data comprises determining, by the service provider data server computer, a telephone number of the user associated with the location data.

10. The method of claim 9, wherein obtaining the enrichment data associated with the user comprises:
querying, by the service provider data server computer, a user database for the enrichment data associated with the telephone number; and
receiving, by the service provider data server computer, from the user database, the enrichment data associated with the telephone number.

11. The method of claim 10, wherein the enrichment data comprises an age of the user, a gender of the user, a country in which the user lives, a country of which the user is a citizen, a city in which the user lives, a marital status of the user, an education level of the user, an interest of the user, a job of the user, a job sector of the user, an income level of the user, a living situation of the user, a time of day the application is used, a time of data another application is used, or any combination thereof.

12. The method of claim 11, wherein the operations further comprise aggregating, by the service provider data server computer, the enrichment data to create aggregated enrichment data, and wherein providing the enrichment data associated with the user to the application comprises providing the aggregated enrichment data associated with the user to the application.

13. The method of claim 8, wherein the enrichment data comprises an age of the user, a gender of the user, a country in which the user lives, a country of which the user is a citizen, a city in which the user lives, a marital status of the user, an education level of the user, an interest of the user, a job of the user, a job sector of the user, an income level of the user, a living situation of the user, a time of day the application is used, a time of data another application is used, or any combination thereof.

14. The method of claim 13, wherein providing, by the service provider data server computer, the enrichment data associated with the user to the application comprises providing, by the service provider data server computer, the enrichment data associated with the user to the application so that the application can utilize the enrichment data to target the user for a specific advertisement.

15. A computer storage medium that stores computer-readable instructions that, when executed by a processor, cause the processor to perform operations comprising:
collecting location data in response to an application being launched on a user device;
providing the location data to a service provider data server computer;
receiving, from the service provider data server computer, enrichment data associated with a user of the user device; and
determining a specific advertisement based upon the enrichment data.

16. The computer storage medium of claim 15, wherein the operations further comprise presenting the specific advertisement based upon the enrichment data to the user.

17. The computer storage medium of claim 15, wherein collecting the location data comprises collecting the location data via an application programming interface exposed by the service provider data server computer.

18. The computer storage medium of claim 15, wherein the enrichment data comprises an age of the user, a gender of the user, a country in which the user lives, a country of which the user is a citizen, a city in which the user lives, a marital status of the user, an education level of the user, an interest of the user, a job of the user, a job sector of the user, an income level of the user, a living situation of the user, a time of day the application is used, a time of data another application is used, or any combination thereof.

19. The computer storage medium of claim 18, wherein the enrichment data is aggregated by the service provider data server computer to create aggregated enrichment data, and wherein receiving, from the service provider data server computer, the enrichment data associated with the user of the user device comprises receiving, from the service provider data server computer, the aggregated enrichment data.

20. The computer storage medium of claim 15, wherein the user is a subscriber of a telecommunication service provided by a service provider associated with the service provider data server computer.
